(19) United States
(12) Patent Application Publication
(10) Pub. No.: US 2018/0137363 A1
(43) Pub. Date: May 17, 2018

(54) SYSTEM FOR THE AUTOMATED ANALISYS OF A SPORTING MATCH

(71) Applicant: MAS-TECH S.R.L., Cavezzo (IT)

(72) Inventors: Donato Campagnoli, San Possidonio (IT); Andrea Prati, Modena (IT); Ettore Stella, Bari (IT); Nicola Mosca, Triggiano (IT); Vito Reno', Bari (IT); Massimiliano Nitti, Bitritto (IT)

(21) Appl. No.: 15/564,094

(22) PCT Filed: Apr. 1, 2016
(86) PCT No.: PCT/IB2016/051883

§ 371 Date: Oct. 3, 2017

Related U.S. Application Data
(60) Provisional application No. 62/142,894, filed on Apr. 3, 2015.

(51) Int. Cl. G06K 9/00; G06F 17/30; G01S 3/786

(52) U.S. Cl. CPC G06K 9/00724; G01S 3/7864; G06K 9/00671; G06F 17/30811

(57) ABSTRACT

The System for the automated analysis of a sporting match comprises:
a video acquisition module for receiving video data related to a tennis match;
a video processing module operatively connected to the video acquisition module and suitable for processing the video data;
a database operatively connected to the video processing module and suitable for saving the processed video data;
a debriefing module operatively connected to the database for the debriefing of the processed video data on at least a user device;
   wherein the video processing module comprises a high-level analysis unit for generating high-level statistic data from the processed video data.

### CROSS REFERENCE TO RELATED APPLICATION(S)

This application is a U.S. National Stage Entry of International Patent Application No. PCT/IB2016/051883, filed Apr. 1, 2016, which claims the benefit of U.S. Provisional Patent Application No. 62/142,894, filed Apr. 3, 2015, the disclosures of which are hereby incorporated entirely herein by reference.

### BACKGROUND

### Technical Field

The invention relates to a system for the automated analysis of a sporting match. Particularly, the system allows the automated real-time and close to real-time analysis of a sporting match.

Preferably, the sporting match analysed by the system is a tennis match, wherein motion information is gathered by one or more cameras situated in proximity to a tennis court.

However, the invention also relates to the analysis of singles and doubles match play and of other racquet sports including, but not limited to, racquetball, frontennis and squash.

### Background Art

Many sporting events are considered spectator sports. One such sport is tennis.

Tennis matches are viewed by millions of people each year through television technology, which enables images of a sporting match to be delivered via radio waves, satellite signals or cable signals to televisions around the world

In the course of a sporting event such as tennis, a point or a series of points will sometimes be “replayed” for the viewer. This involves locating the point in one or more digital files where a motion sequence begins, and then re-playing that segment of the file for the public or official review.

Such a replay is often presented by announcers with additional analysis and dramatic effect and it may sometimes be shown from different angles using different files representing video acquisition data taken by different cameras.

Recently, technology has been developed that allows the travel of a tennis ball relative to the boundaries of a tennis court to be displayed.

This technology relies upon the placement of a series of cameras around the court. The cameras store video information representing the flight of the ball, and this data is then processed relative to pre-stored information concerning the lines of the tennis court.

Such technology has developed to the point that an instantaneous replay of the flight of a ball may be presented in virtually real time in order to determine qualitatively whether a line judge's call was correct. Such instances are referred to in the sport of tennis as “challenges.”

Software has more recently been developed that allows an individual or sports media company to record specific instances of ball travel within a tennis court (or other court), and then analyse those instances to determine player tendencies or trends. For example, video analysis is sometimes employed to determine the locations at which a player streaks a ball relative to the baseline during the course of rallies, or during service returns.

Video analysis may also be employed to determine the locations at which a ball lands in a court relative to the baseline, or relative to a service box, during the course of a match.

However, analysis systems of the known type can be improved, in particular in such a way as to obtain more precise and detailed statistical information and a more functional and innovative visualization of the information thus obtained.

Particularly, the most relevant prior art is reported in two previous documents.

Document US 2015/0018990 A1 discloses the use of at least two cameras to extract in real-time statistics about the ball and the players, and to determine pattern behaviours.

However, the disclosed solution does not allow the extraction of high-level cross-over/transversal statistics and, therefore, does not allow a more insightful analysis of the player performance aimed at improving player's skills.

Furthermore, the known solution does not have an advanced interface module capable for providing simple yet effective suggestions for the player.

Finally, the known solution is limited to the use of at least two cameras in order to extract the real-time statistics.

Document WO 98/55190 disclosed a system for both ball and player tracking in a tennis court. Also this solution relies on at least two cameras to work properly.

Moreover, high-level cross-over statistics are not covered in it.

### SUMMARY

The main aim of the present invention is to provide a system for the automated analysis of a sporting match that allows the real-time and close to real-time generation of high-level statistic information about a tennis match or the like.

One object of the present invention is to provide a system for the automated analysis of a sporting match that allows a user to employ a conventional camera that is part of a so-called “smart-phone” (or other device having a transceiver and an appropriate application software program [“App”] installed), to record video motion of players on a tennis court, and then get simulations of that play by uploading the video acquisition data to a server.

A further object of the present invention is to provide a system for the automated analysis of a sporting match that allows the processing of acquired video in order to obtain virtual reality or augmented reality video images.

A further object of the present invention is to provide a system for the automated analysis of a sporting match that allows a user having a smart-phone (or other device having a transceiver) to receive and display processed images from multiple cameras at strategic court locations.

### BRIEF DESCRIPTION OF THE DRAWINGS

FIG. 1 is a schematic view of a tennis court with a multiple-camera first embodiment of the system according to the invention.

FIG. 2 is a schematic view of the first embodiment of the system according to the invention.

FIG. 3 is a more detailed schematic view of the system of FIG. 2.

FIG. 4 is a flow chart showing in details the steps performed by a ball detection and tracking units and by a player detection and tracking unit of the system according to the invention.

FIGS. 5, 6, 7 and 8 are flow charts showing in details the steps performed by a ball trajectory reconstruction unit, a point classification units and a classification fusion unit, according to the first embodiment of the system.

FIG. 9 is a schematic view of a tennis court with a single-camera first embodiment of the system according to the invention.

FIG. 10 is a schematic view of the second embodiment of the system according to the invention.

FIG. 11 is a more detailed schematic view of the system of FIG. 10.

FIG. 12 is a flow chart showing in details the steps performed by a ball detection and tracking unit and by a player detection and tracking unit of the system according to the invention.

FIGS. 13, 14, 15 and 16 are flow charts showing in details the steps performed by a ball trajectory reconstruction unit, a point classification unit and a classification fusion unit, according to the second embodiment of the system.

FIG. 17 schematizes a background subtraction process performed by the system according to the invention.

FIG. 18 shows an example of finite state automata for the analysis of an action.

FIGS. 19 and 20 illustrate examples of filtering functions of the system according to the invention.

FIG. 21 is a detailed schematic view of a debriefing module of the system according to the invention.

FIGS. 22, 23 and 24 provide examples of computer-generated images of a simulated tennis court generated by the system according to the invention.

FIGS. 25, 26 and 27 are schematic photographic views of a tennis point elaborated by a system according to the invention and with added contextual information.

FIG. 28 and FIG. 29 are further augmented reality examples.

FIG. 30 is a flow chart showing the overall operation of the system according to the invention, in the first embodiment.

FIG. 31 is a flow chart showing the overall operation of the system according to the invention, in the second embodiment.

### WAYS OF CARRYING OUT THE INVENTION

The systems 100, 200 according to the invention is a debriefing system for the analysis of tennis matches, of the development of the game and single shots, which is able to produce and collect in real-time and close to real-time a set of high-level cross-over statistics about the players, the ball and the match in general with the use of no operators.

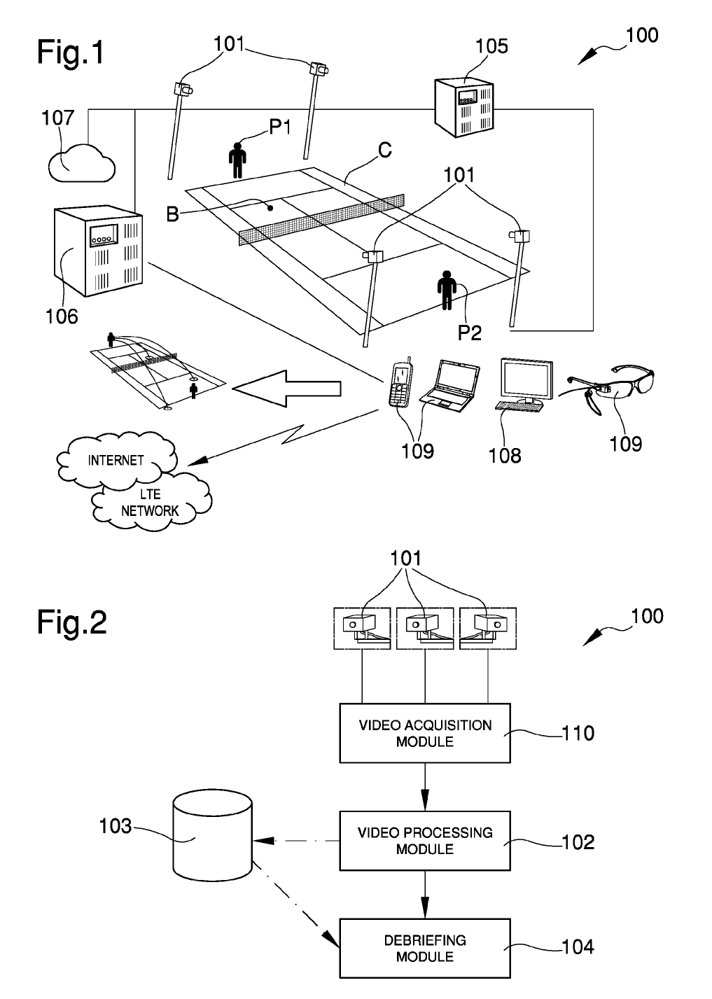

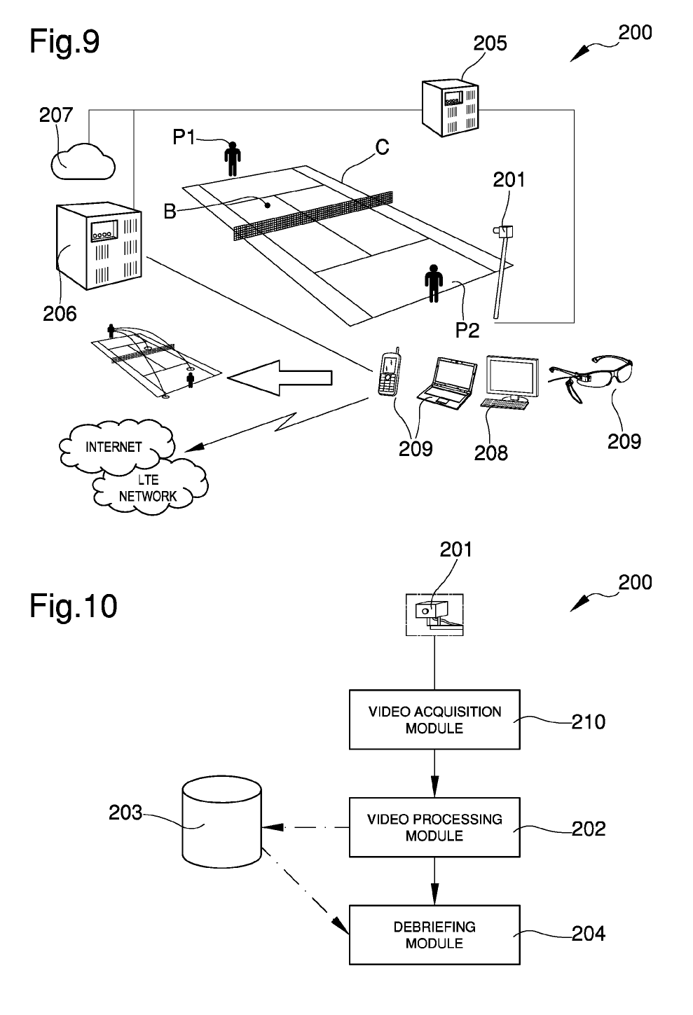

The system 100, 200 automatically collects this statistic through the use of at least one fixed camera 101, 201 (as shown in FIGS. 1 and 9 for example) and advanced computer vision algorithms.

Moreover, the statistics are exploited also for an innovative fruition of the match analysis by means of a marker-less overlay of virtual rendering of extracted data to the real live feeds via a mobile camera integrated in a mobile device such as a smart-phone, a tablet, a UAV/drone or a wearable device (such as Microsoft HoloLens® or Google Glasses®, for example).

Particularly, the system 100, 200 preferably comprises two main modules, disjoint and interchangeable.

A first video processing module 102, 202 allows the automatic analysis by means of tools for extracting, storing and organizing data about the match, the 2/4 players, the ball and the surroundings. Both the raw and processed data are stored in a relational database 103, 203 and serve as the basis for further aggregation at mid and high-levels of the statistics.

A second debriefing module 104, 204 exploits virtual reality (VR) and augmented reality (AR) to provide the user with the statistics by means of insightful and innovative means.

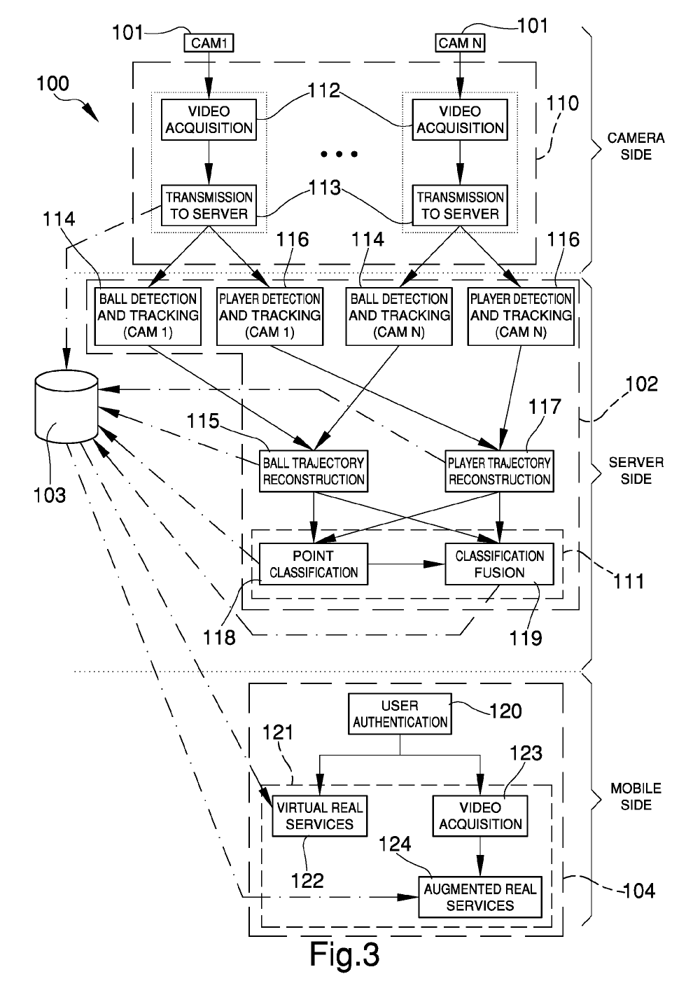

According to a first possible embodiment of the present invention schematically illustrated in FIG. 1 and further detailed in FIGS. 2, 3, 4, 5, 6, 7, 8 and 19, the system 100 comprises a plurality of on-site cameras 101.

Particularly, FIG. 1 is a schematic view of a tennis court C having boundaries and a net and provided with a first possible embodiment of the system 100 according to the invention.

According to this first embodiment, the system 100 comprises multiple cameras 101 (four cameras are showed in FIG. 1) placed around the court C in order to acquire video data.

It is understood that the cameras 101 may themselves be cameras of mobile devices, such as smart-phone, tablets or the like. However, dedicated video recording devices are preferred.

The cameras 101 are positioned so that every stereo couple sees exactly a player P1, P2 (or even two in the case of a doubles) and the ball B, if present. So, in every acquired image the system 100 will determine the image position of the ball B and the silhouette of the players P1, P2.

Particularly, the cameras 101 determine the 3D position of objects of interest on-court via the technique of stereo-vision.

Preferably, the video data acquisition of the cameras 101 is synchronized via a hardware trigger signal (TTL) generated by an external synchronization device, not shown in the figure. Furthermore, a referral measurement system can be located in the middle of the court C and oriented. The absolute position of the pairs of cameras 101 in the considered referral system can be provisionally determined with a theodolite.

Therefore, all cameras 101 take a frame of the same scene at every moment.

Wireless and/or wired transmission of the acquired video data could be made to a local server 105, to a remote server 106, and/or to the cloud 107.

The acquired data is then processed as discussed below and transmitted to a receiver in the user or viewer side for simulated viewing.

Particularly, the processing of the acquired video data determines the 3D position of the ball B (if present in the scene) and of the players P1, P2 in order to:
determine through interpolation the equation of the trajectory of the ball B in the space, and extract the impact position of the ball B on the ground (bounce);
determine the inversion in the movement of the ball B which indicates the player's hit; and
determine the 3D position of the players P1, P2 on-court.

On the user side, viewing may be done through a desktop computer 108, or via a mobile device 109 such as a smart-phone, wearables (such as Microsoft HoloLens® or Google Glasses®), a tablet, or a laptop.

According to the scheme of FIG. 2, the first embodiment of the system 100 comprises a video acquisition module 110. The plurality of cameras 101 is operatively connected to the video acquisition module 110 and is suitable for supplying video data to the video acquisition module itself.

Furthermore, the system 100 comprises a video processing module 102 operatively connected to the video acquisition module 110.

The video processing module 102 supplies via data pathway processed video data to a database 103.

The system 100 further comprises a debriefing module 104 operatively connected to the database 103 for the debriefing on a user device 108, 109. The database 103 supplies processed video data to the debriefing module 104 via a data pathway.

Advantageously, the video processing module 102 comprises a high-level analysis unit 111 for generating high-level cross-over statistic data from said processed video data.

It is pointed out that each of the modules 110, 102, 104 of the system 100 is implemented by means of dedicated hardware and software modules.

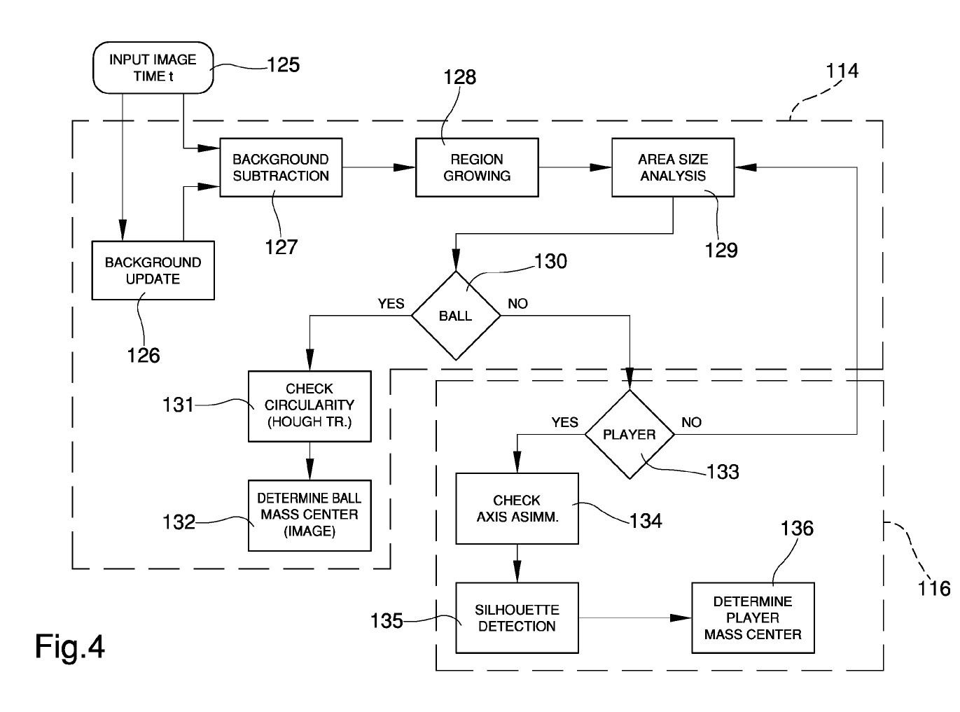

FIG. 3 show a more detailed level data-flow of the video acquisition module 110, of the video processing module 102 and of the debriefing module 104 according the first possible embodiment of the system 100 of FIG. 2.

Particularly, FIG. 3 presents a data-flow for a multi-camera system 100. Here, two illustrative cameras 101 are shown, though it is understood that the system 100 may contain a different number of cameras 101.

The video acquisition module 110 can be a camera side module. This module can be installed in each of the system's cameras 101 and is devoted to the video acquisition. However, different embodiments are not excluded wherein the video acquisition module 110 is implemented as a server side module.

Particularly, the video acquisition module 110 comprises a plurality of video acquisition units 112 respectively connected to each camera 101.

Furthermore, the video acquisition module 110 comprises a plurality of transmission units 113 connected to respective video acquisition units 112 and suitable for the transmission of the video data acquired to the database 103 of a server 105, 106 of the system 100.

As showed in FIG. 3, the video processing module 102 is a server side module, and preferably resides in a local server 105.

However, alternative embodiments contemplate implementation across one or more local servers 105, remote servers 106 and cloud architectures 107.

The video processing module 102 is responsible for the processing of video feeds received from the cameras 101.

Preferably, the analysis method used by the video processing module 102 has two levels of processing of the video sequences: a first level where the images of each camera 101 are independently processed, and then a second level where the analysis of the frames related to the same moment, and this for each stereo camera couple, are integrated in order to get, via triangulation, the 3D positions of the ball B and of the players P1, P2.

The goal of the first level is to determine objects in movement in every picture. In a tennis match all these objects are as follows: the ball B and the players P1, P2.

The preferred method used for the detection of mobile objects preferably is the so-called method of the “background subtraction”, called PIIB (V. Renò, R. Marani, T. D'Orazio, E. Stella, M. Nitti, An adaptive parallel background model for high-throughput video applications and smart cameras embedding, International Conference on Distributed Smart Cameras (ICDSC 2014) Venezia (Italy)) developed by ISSIA.

Particularly, the video processing module 102 includes a plurality of ball detection and tracking units 114 for detecting and tracking the ball B trajectory from the video data acquired by each camera 101. Both the ball detection and tracking units 114 are connected to a ball trajectory reconstruction unit 115.

The video processing module 102 further includes a plurality of player detection and tracking units 116 for detecting and tracking the player P1, P2 position from the video data acquired by each camera 101.

Both the player detection and tracking units 116 are connected to a player trajectory reconstruction unit 117.

Advantageously, the high-level analysis unit 111 comprises a point classification unit 118 combined with a classification fusion unit 119.

Particularly, the point classification unit 118 provides low-level data and mid-level data related to the match dynamics while the classification fusion unit 119 provides high-level data starting from the obtained low-level data and mid-level data.

Both the ball trajectory reconstruction unit 115 and the player detection and tracking units 116 are connected to the point classification unit 118.

The ball trajectory reconstruction unit 115, the player trajectory reconstruction unit 117 and the point classification unit 118 are connected to the classification fusion unit 119.

The obtained low-level, mid-level and high-level cross-over statistics are stored in the database 103 (eventually in more databases 103, one or more local servers 105, remote servers 106 and/or cloud architectures 107).

Usefully, the cameras 101 connected to the video acquisition module 110 can be calibrated through respective calibration units, not showed in FIG. 3.

Finally, the debriefing module 104 resides on the user or viewer side. Preferably, as illustrated in FIG. 3, the debriefing module 104 resides on mobile devices 109 (smart-phone, tablet, wearable device) or in personal computers 108.

The debriefing module 104 comprises a user authentication unit 120 and a viewer unit 121 for viewing the processed video data from the database 103 as collected by the video processing module 102 on the server side.

Data may be shown to the user either by virtual reality services, by means of a virtual reality unit 122, or by augmented reality services, by means of a video acquisition unit 123 operatively connected to an augmented reality unit 124.

The remote server 106 and remote control unit host all delivery functions associated with the database 103 of the system 100.

Debriefing tools such as video clips, summary data, 3D rendering in VR, and marker-less AR solutions about the game are available via the Web or a mobile network through a dedicated application for download to the user or viewer side with a 3G/4G connection.

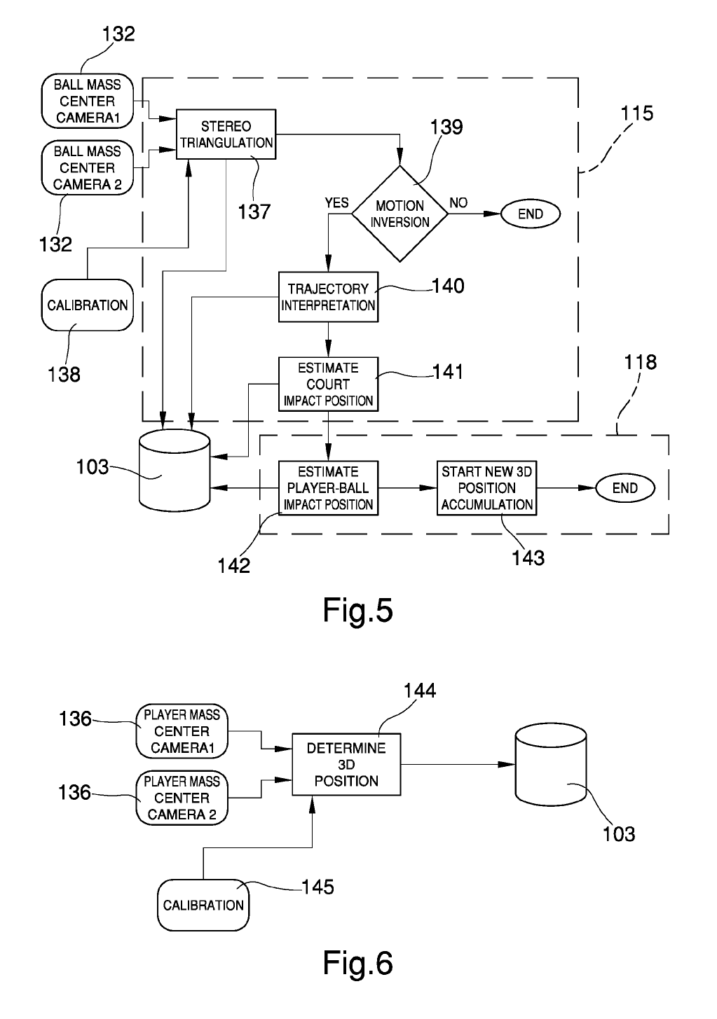

The following FIGS. 4, 5 and 6 demonstrate how tennis ball movement data and player movement data are captured. These figures also show flow charts for operational sequences for capturing images and filtering those images for presentation to analytical software.

Particularly, FIG. 4 is a flow chart showing in details the steps performed by the ball detection and tracking units 114 and by the player detection and tracking units 116, according to a possible embodiment.

First, the video processing module 102 comprises an input image block 125 that provides an image time “t”. This image is transmitted to a background update block 126, and separately to a background subtraction block 127 of the ball detection and tracking unit 114.

The background subtraction block 127 automatically computes the background (intended as part of the image which is not in motion) and subtracts it from the current image to generate the moving parts of the image. Theoretically, the moving parts of the image are constituted by the players P1, P2 and the ball B.

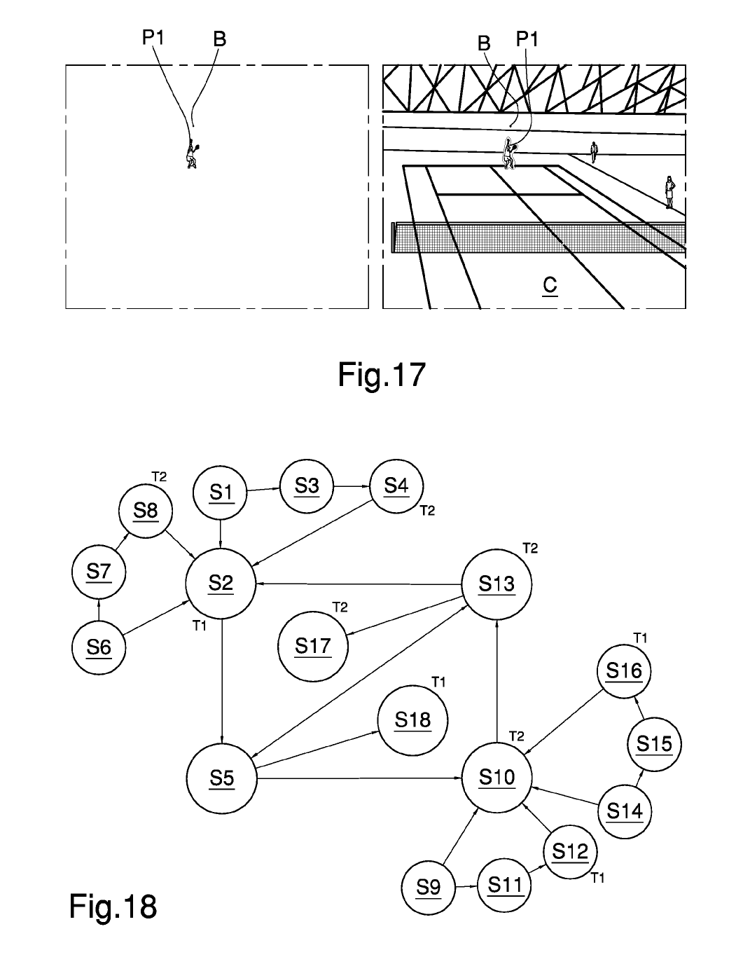

As an example, FIG. 17 is a schematic representation of the background subtraction from the original images.

Particularly, FIG. 17 schematizes a photographic view of a tennis court C, wherein are illustrated the extracted image of the player P1 and the extracted image of the tossed ball B (left image), while the silhouette of the player P1 and the ball B are in highlighted on the original image (on the right).

After the background subtraction, a region growing block 128 aggregates all areas of interest related to the ball B and to the player P1. The selection of these areas is initially made via thresholding in order to determine the regions whose area is close to the objects of interest.

Particularly, the background subtraction block 127 communicates the processed image to the region growing block 128, which grows the regions detected by the background subtraction block 127 to connect adjacent regions and obtain regions better describing the objects to be detected.

The region growing block 128 finds flawed or unsatisfactory occurrences of objects within a certain class of shapes, e.g., tennis balls, using a voting procedure.

Preferably, the ball candidate areas are verified with a circularity test (Hough transform). For the bigger areas, a player candidate is selected according to the size of the area and to the asymmetry of the main axis. The shades are first cancelled from the player candidate with an analysis of the colour and the silhouette of the player is detected with a border follower on the remaining area.

Particularly, the output of the region growing block 128 is processed by an area size analysis block 129. The area size analysis block 129 detects and considers the larger areas of greatest interest.

Then, if the ball decision block 130 determines that the object is a ball B, it transfers the data to a circularity checking block 131 for checking the circularity of the ball B and, subsequently, to a ball mass center determination block 132.

Differently, if the ball decision block 130 determines that the object is not a ball B, it transfers the data to a player decision block 133 of the player detection and tracking unit 116.

If the player decision block 133 determines that the object is, in fact, a player P1, then the analysis is transferred to a check axis asymmetry block 134.

From there the object is subjected to a silhouette detection block 135 and, subsequently, to a player mass center determination block 136, which determines the player's mass center location.

Otherwise, if the player decision block 133 did not detect a player P1, the analysis is recycled to the area size analysis block 129 for processing a next object of the region growing block 128 results.

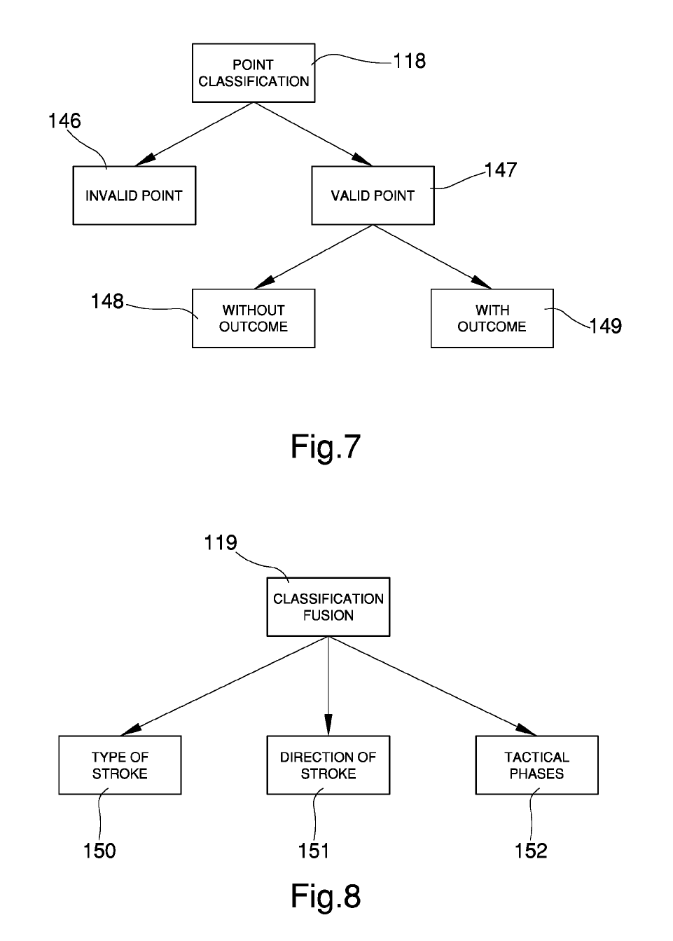

FIGS. 5, 6, 7 and 8 present flow charts showing in details the steps performed by the ball trajectory reconstruction unit 115, the point classification unit 118 and the classification fusion unit 119, according to a possible embodiment.

Particularly, in FIG. 5, ball movement data is analysed; in FIG. 6, player movement data is processed.

Referring first to FIG. 5, each ball mass center determination block 132 communicates the determined ball mass center to a stereo triangulation block 137 of the ball trajectory reconstruction unit 115.

The stereo triangulation block 137 provides accuracy for increased ball 3D location accuracy.

Particularly, the synchronized images of each stereo couple of cameras 101 are triangulated in order to determine the 3D position of the ball B and of the related player P1, P2.

Furthermore, a calibration block 138 communicates with the stereo triangulation block 137.

Therefore, the triangulation may be done by determining, during a calibration phase via theodolite, the position in the referral system of the cameras 101 (focus) and of special points on the ground, recognizable on the image plan (line crossing for instance). While using the markers on the ground and their projections on the image plan, it is possible to determine a plan conversion (image plan and ground) in order to map points on the image plan on the ground. The 3D estimation is made while crossing the lines through between the focus of the cameras and the points corresponding to the points of interest, mapped on the ground.

This procedure of calibration is needed only at system 100 set-up, and assumes that the cameras 101 are in a fixed position.

Furthermore, the stereo triangulation block 137 communicates with the database 103, and also with a motion inversion decision block 139.

The motion inversion decision block 139 communicates with a trajectory interpretation block 140. If motion inversion (typically ball-to-racquet impact) is determined, this is communicated to the trajectory interpretation block 140.

The trajectory interpretation block 140 communicates the trajectory information back to the database 103. Additionally, the trajectory interpretation block 140 sends data to an estimate court impact position block 141.

The estimate court impact position block 141 communicates the estimated court position to the database 103. At the same time, the estimate court impact position block 141 sends data to an estimate player-ball impact position block 142 of the point classification unit 118.

The estimated player-ball impact position block 142 communicates the impact position of the ball B to the database 103. At the same time, the impact position of the ball B is sent to a start new 3D position accumulation block 143.

Subsequently, the incremental process sequence of FIG. 5 ends. Alternatively, if no motion inversion is detected in block 139, the sequence will end.

As noted, FIG. 6 shows a flowchart for processing player P1, P2 movement data.

Particularly, the player mass center blocks 136 of the player detecting and tracking units 116 communicate that data to a 3D Position determination block 144. At the same time, a calibration block 145 communicates to the 3D position determination block 144 to orient player position.

Player position information from the 3D position determination block is communicated to the database 103.

In FIG. 7 further details of possible actions of the point classification unit 118 are schematically illustrated.

Particularly, the point classification unit 118 is responsible for assigning an outcome—if there is one—to a point.

First, the point classification unit 118 divides the point in invalid point 146 or valid point 147.

Then, for each valid point 147 the point classification unit 118 analyses the outcome exploiting 3D coordinates of both players P1, P2 and ball B.

A knowledge model of “what a proper point is” is embedded inside the point classification unit 118. This means that the system 100 can understand if the players P1, P2 are training (i.e. a period of time during which players P1, P2 are free to move wherever they want and practice difficult or unusual strokes/game tactics) or playing a match, and therefore can assign an outcome when required.

As an example, the point classification unit 118 generates an invalid point 146 when a player P1, P2 does not assume the position of a tennis server, according to the rules of the game. An example of invalid point 146 is when a player P1 is just passing the ball B over to the other player P2, between two valid points.

Differently, a valid point 147 occurs when the correct player (according to the evolution of match) performs the service. The valid point 147 starts from this event and can evolve in one of the following cases:
point without outcome 148;
point with outcome 149.

The point without outcome 148 is the case when a decision about score assignment can not be done, for example because of a fault. The tennis server can repeat the serve. The point with outcome 149 is the case when a decision about score assignment can be done. The serve has been done correctly and the point can evolve. At the end of this phase, one of the players (or teams) achieves the point (point won). As a consequence, the other player loses the point.

In FIG. 8 further details of possible actions of the classification fusion unit 119 are schematically illustrated.

Classification fusion unit 119 is responsible for exploiting information about sensible key entities involved during the game as well as point classification (if any) in order to extract high-level information.

The classification fusion unit 119 combines entities attributes (e.g. player position with respect to the ball) in order to give to the system 100 the capability of high-level events evaluation.

As an example, the following information can be obtained by the classification fusion unit 119 only by fusing data and introducing domain knowledge about the game:
type of stroke 150;
direction of stroke 151;
tactical phases 152.

For example, among possible types of stroke 150 are the following: forehand, backhand, smash, volley smash, bounce smash, serve, 1st serve, 2nd serve, return, return to 1st serve, return to 2nd serve, forehand volley, backhand volley, drop-shot, half-volley, lob.

For example, possible types of direction of stroke 151 are the following: cross court, down the line.

For example, among possible types of tactical phases 152 are the following: attack, construction, defense.

High-level information is stored in the database 103 in order to enrich low-level and medium-level information that has already been stored.

Data can be further exploited in the subsequent modules to perform statistical analyses as well as information retrieval.

Usefully, it is pointed out that a huge amount of data stored in a common database encourage the use of data mining techniques and pattern recognition algorithms. This enables better understanding of hardly exploitable relations between entities involved during the game.

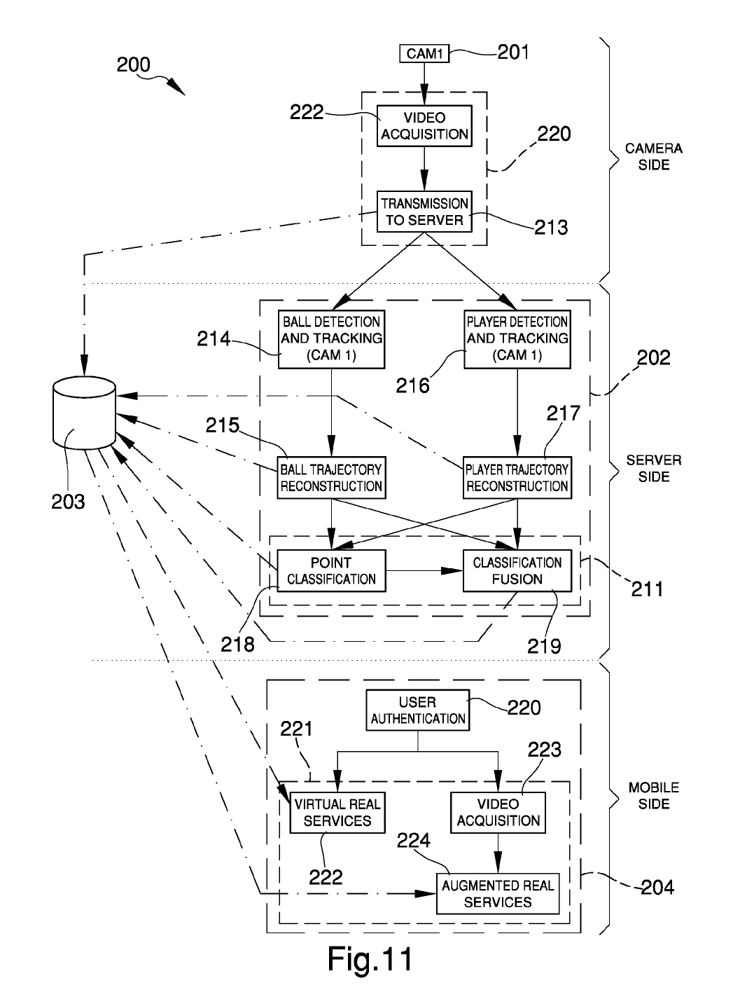

According to a second possible embodiment of the present invention schematically illustrated in FIG. 9 and further detailed in FIGS. 10, 11, 12, 13, 14, 15, 16 and 19, the system 200 comprises a single camera 201.

Particularly, FIG. 9 is a schematic view of a tennis court C having boundaries and a net and provided with a first possible embodiment of the system 200 according to the invention.

According to this second embodiment, the system 200 comprises a single on-site camera 201 placed adjacent the court C in order to acquire video data.

Usefully, the camera 201 may be the camera of a mobile device, such as a tablet or the like. However, dedicated video recording devices are preferred.

Wireless and/or wired transmission of the acquired video data is made to a local server 205, to a remote server 206, and/or to the cloud 207.

The acquired data is then processed as discussed below and transmitted to a receiver in the user or viewer side for simulated viewing.

On the user side, viewing may be done through a desktop computer 208, or via a mobile device 209 such as a smart phone, wearables (such as Microsoft HoloLens® or Google Glasses®), a tablet, or a laptop.

It is pointed out that the system 200 according to the second embodiments shares many of the considerations including services and algorithms described for the multi-camera system 100 according to the first embodiment, but is intended for a different audience and with slightly different purposes.

The multi-camera system 100 is more expensive, and its potential customers are professionals and administrative bodies in the field of tennis assessment and training (federations, clubs, resorts, etc.). On the other hand, the one-camera system 200 is intended for a more general public (and thus wider audience and more customers), including coaches' education, coaches/trainers, tennis broadcasters, general tennis fans, or bettors.

According to the scheme of FIG. 10, the second embodiment of the system 200 comprises a video acquisition module 201. The camera 201 is operatively connected to the video acquisition module 210 and is suitable for supplying video data to the video acquisition module itself.

Furthermore, the system 200 comprises a video processing module 202 operatively connected to the video acquisition module 210.

The video processing module 202 supplies via data pathway processed video data to the database 203.

The system 200 further comprises a debriefing module 204 operatively connected to the database for the debriefing on a user device 208, 209. The database 203 supplies processed video data to the debriefing module via a data pathway.

Advantageously, the video processing module 202 comprises a high-level analysis unit 211 for generating high-level statistic data from said processed video data.

It is pointed out that each of the modules 210, 202, 204 of the system 100 is implemented by means of dedicated hardware and software modules.

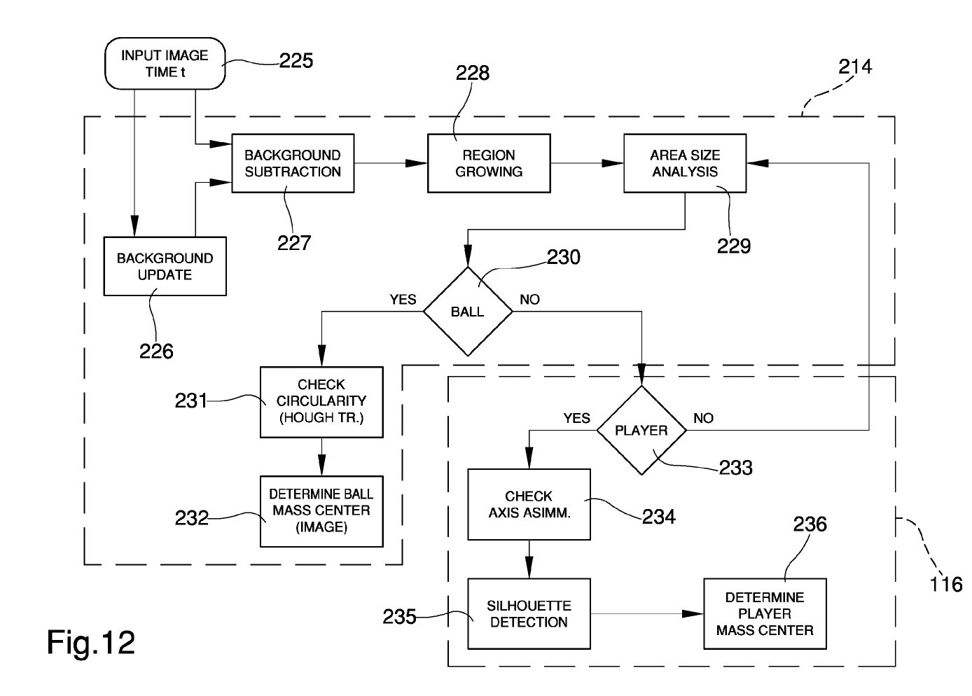

FIG. 11 show a more detailed level data-flow of the video acquisition module 210, of the video processing module 202 and of the debriefing module 204 according the second possible embodiment of the system 200 of FIG. 10.

Particularly, FIG. 11 presents a data-flow for a single-camera system 200. Here, a single HD camera 201 is shown.

The video acquisition module 210 is a camera side module. This module is installed in the system's camera 201 and is devoted to video acquisition.

Particularly, the video acquisition module 210 comprises a video acquisition unit 212 connected to the camera 201.

Furthermore, the video acquisition module 210 comprises a transmission unit 213 connected to the video acquisition unit 212 and suitable for the transmission of the video data acquired to a database 203 of a server 205, 206 of the system 200.

As showed in FIG. 11, the video processing module 202 is a server side module, and preferably resides in a local server 205.

However, alternative embodiments contemplate implementation across one or more local servers 205, remote servers 206 and cloud architectures 207.

The video processing module 202 is responsible for the processing of video feeds received from the camera 201.

Particularly, the video processing module 202 includes a ball detection and tracking unit 214 for detecting and tracking the ball B trajectory from the video data acquired by the camera 201. The ball detection and tracking unit 215 is connected to a ball trajectory reconstruction unit 215.

The video processing module 202 further includes a player detection and tracking unit 216 for detecting and tracking the player P1, P2 position from the video data acquired by the camera 201. The player detection and tracking unit 216 is connected to a player trajectory reconstruction unit 217.

Advantageously, the high-level analysis unit 211 comprises a point classification unit 218 combined with a classification fusion unit 219.

Particularly, the point classification unit 218 provides low-level data and mid-level data related to the match dynamics while the classification fusion unit 219 provides high-level data starting from the obtained low-level data and mid-level data.

Both the ball trajectory reconstruction unit 215 and the player detection and tracking units 216 are connected to the point classification unit 218.

The ball trajectory reconstruction unit 215, the player trajectory reconstruction unit 217 and the point classification unit 218 are connected to the classification fusion unit 119.

The obtained low-level statistics, mid-level statistics and high-level statistics are stored in the database 203 (eventually in more databases 203, one or more local servers 205, remote servers 206 and/or cloud architectures 207).

Usefully, the camera 201 connected to the video acquisition module 201 is calibrated through a calibration unit, not showed in FIG. 11.

Finally, the debriefing module 204 resides on the user or viewer side. Preferably, as illustrated in FIG. 11, the debriefing module 204 resides on mobile devices 209 (smart-phone, tablet, wearable device).

The debriefing module 204 comprises a user authentication unit 220 and a viewer unit 221 for viewing the processed video data from the database 203 as collected by the video processing module 202 on the server side.

Data may be shown to the user either by virtual reality services, by means of a virtual reality unit 222, or by augmented reality services, by means of a video acquisition unit 223 operatively connected to an augmented reality unit 224.

The remote server 206 and remote control unit host all delivery functions associated with the database 203 of the system 200.

Debriefing tools such as video clips, summary data, 3D rendering in VR, and marker-less AR solutions about the game are available via the Web or a Mobile network through a dedicated application for download to the user or viewer side of system with a 3G/4G connection.

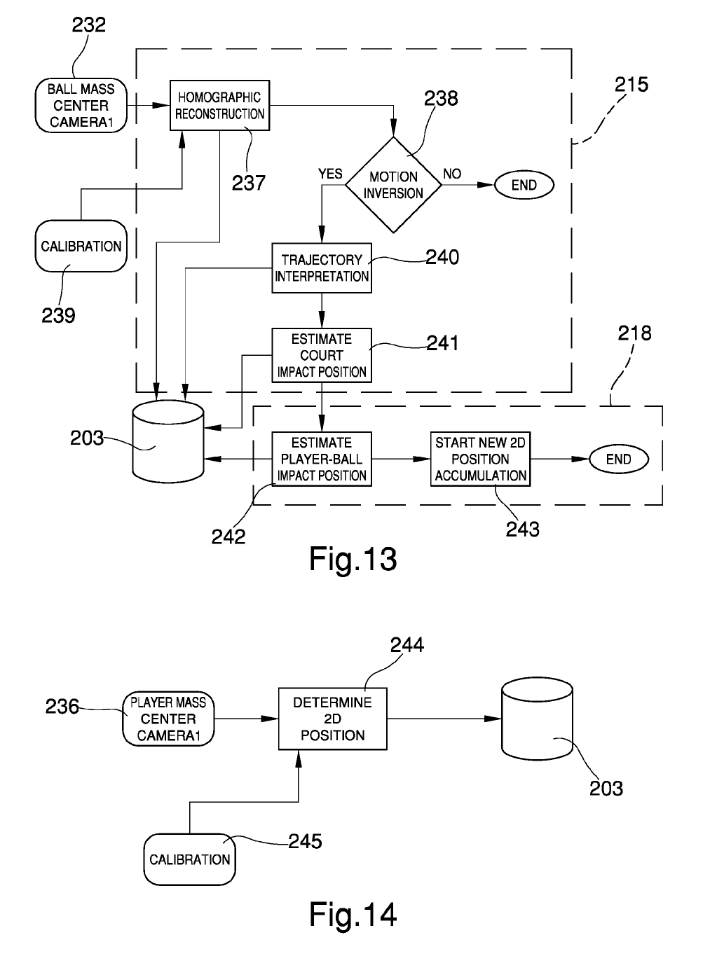

The following FIGS. 12, 13 and 14 demonstrate how tennis ball movement data and player movement data are captured. These figures also show flow charts for operational sequences for capturing images and filtering those images for presentation to analytical software.

Particularly, FIG. 12 is a flow chart showing in details the steps performed by the ball detection and tracking unit 214 and by the player detection and tracking unit 216, according to a possible embodiment.

First, the video processing module 202 comprises an input image block 225 that provides an image time “t”. This image is transmitted to a background update block 226, and separately to a background subtraction block 227 of the ball detection and tracking unit 214.

The background subtraction block 227 automatically computes the background (intended as part of the image which is not in motion) and subtracts it from the current image to generate the moving parts of the image. Theoretically, the moving parts of the image are constituted by the players P1, P2 and the ball B.

As an example, FIG. 17 t is a schematic representation of he background subtraction from the original images.

Particularly, FIG. 17 is a schematic representation of a photographic view of a tennis court C, wherein are illustrated the extracted image of the player P1 and the extracted image of the tossed ball B (left image), while the silhouette of the player P1 and the ball B are in highlighted on the original image (on the right).

After the background subtraction, a region growing block 228 aggregates all areas of interest related to the ball B and to the player P1. The selection of these areas is initially made via thresholding in order to determine the regions whose area is close to the objects of interest.

Particularly, the background subtraction block 227 communicates the processed image to the region growing block 228, which grows the regions detected by the background subtraction block to connect adjacent regions and obtain regions better describing the objects to be detected.

The region growing block 228 finds flawed or unsatisfactory occurrences of objects within a certain class of shapes, e.g., tennis balls, using a voting procedure.

Preferably, the ball candidate areas are verified with a circularity test (Hough transform). For the bigger areas, a player candidate is selected according to the size of the area and to the asymmetry of the main axis. The shades are first cancelled from the player candidate with an analysis of the colour in the space and the silhouette of the player is detected with a border follower on the remaining area.

The output of the region growing block 228 is processed by an area size analysis block 229. Particularly, the area size analysis block 229 detects and considers the larger areas of greatest interest.

Then, if the ball decision block 230 determines that the object is not a ball B, it transfers the data to circularity checking block 231 for checking the circularity of the ball B and, subsequently, to ball mass center determination block 232.

Differently, if the ball decision block 230 determines that the object is not a ball B, it transfers the data to a player decision block 233 of the player detection and tracking unit 216.

If the player decision block 233 determines that the object is, in fact, a player P1, P2, then the analysis is transferred to a check axis asymmetry block 234.

From there the object is subjected to a silhouette detection block 235 and, subsequently, to a determine player mass center block 236, which determines the player's mass center location.

Otherwise, if the player decision block 233 did not detect a player P1, P2, the analysis is recycled to the area size analysis block 229 for processing a next object of the region growing block 228 results.

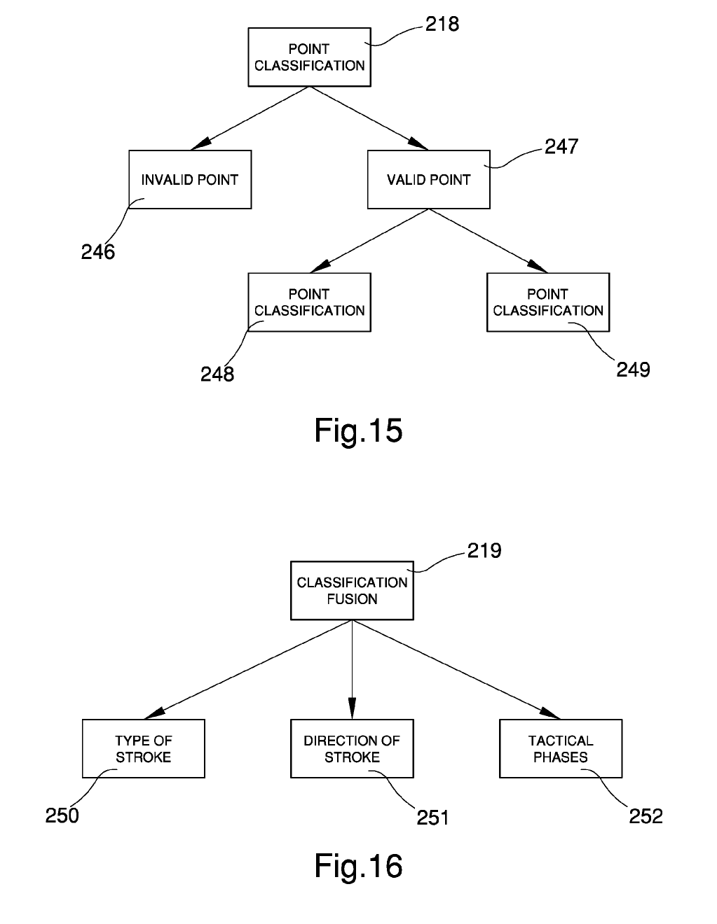

FIGS. 13 and 14 present flow charts showing in details the steps performed by the ball trajectory reconstruction unit 215, the point classification unit 218 and the classification fusion unit 219, according to a possible embodiment.

Particularly, in FIG. 13, ball movement data is analysed; in FIG. 14, player movement data is processed.

Referring first to FIG. 13, the ball mass centre block 232 communicates the data concerning the ball mass center to a homographic reconstruction block 237.

The homographic reconstruction block 237 communicates to the database 203, and also with a motion inversion decision block 238. At the same time, a calibration block 239 communicates with the homographic reconstruction block 237.

The motion inversion block 238 communicates with a trajectory interpretation block 240. If motion inversion (typically ball-to-racquet impact) is determined, this is communicated to the trajectory interpretation block 240.

The trajectory interpretation block 240 communicates the trajectory information back to the database 203. Additionally, the trajectory interpretation block 240 sends data to an estimate court impact position block 241.

The estimate court impact position block 241 communicates an estimated court position to the database 203. At the same time, the estimate court impact position block 241 sends data to an estimate player-ball impact position block 242 of the point classification block 218.

The estimated player-ball impact position data is communicated to the database 203. At the same time, information is sent to a start new 3D position accumulation block 243.

Subsequently, the incremental process sequence of FIG. 13 ends. Alternatively, if no motion inversion is detected in block 238, the sequence will end.

As noted, FIG. 14 shows a flowchart for processing player movement data. The player mass center determination block 236 communicates player mass center data to a 2D position determination block 244. At the same time, a calibration block 245 communicates to the 2D position determination block 244 to orient player position. Player position information from the 2D Position determination block 244 is communicated to the database 203.

In FIG. 15 further details of possible actions of the point classification unit 218 are illustrated.

Particularly, the point classification unit 218 is responsible for assigning an outcome—if there is one—to a point.

First, the point classification unit 218 divides the point in invalid point 246 or valid point 247.

Then, for each valid point 247 the point classification unit 218 analyses the outcome exploiting 2D coordinates of both players P1, P2 and ball B.

A knowledge model of “what a proper point is” is embedded inside the point classification unit 218. This means that the system 100 can understand if the players P1, P2 are training (i.e. a period of time during which players P1, P2 are free to move wherever they want and practice difficult or unusual strokes/game tactics) or playing a match, and therefore can assign an outcome when required.

As an example, the point classification unit 218 generates an invalid point 246 when a player P1, P2 does not assume the position of a tennis server, according to the rules of the game. An example of invalid point 246 is when a player P1 is just passing the ball B to the other player P2, between two valid points.

Differently, a valid point 247 occurs when the correct player (according to the evolution of match) performs the service. The valid point 247 starts from this event and can evolve in one of the following cases:
point without outcome 248;
point with outcome 249.

The point without outcome 248 is the case when a decision about score assignment can not be done, for example because of a fault. The tennis server can repeat the serve.

The point with outcome 249 is the case when a decision about score assignment can be done. The serve has been done correctly and the point can evolve. At the end of this phase, one of the players (or teams) achieves the point (point won). As a consequence, the other player loses the point.

In FIG. 16 further details of possible actions of the classification fusion unit 219 are schematically illustrated.

Classification fusion unit 219 is responsible for exploiting information about sensible key entities involved during the game as well as point classification (if any) in order to extract high-level information.

The classification fusion unit 219 combines entities attributes (e.g. player position with respect to the ball) in order to give to the system 200 the capability of high-level events evaluation.

As an example, the following information can be obtained by the classification fusion unit 219 only by fusing data and introducing domain knowledge about the game:
type of stroke 250;
direction of stroke 251;
tactical phases 252.

For example, among possible types of stroke 250 are the following: forehand, backhand, smash, volley smash, bounce smash, serve, 1st serve, 2nd serve, return, return to 1st serve, return to 2nd serve, forehand volley, backhand volley, drop-shot, half-volley, lob.

For example, possible types of direction of stroke 251 are the following: cross court, down the line.

For example, among possible types of tactical phases 252 are the following: attack, construction, defense.

High-level information is stored in the database 203 in order to enrich low-level and medium-level information that has already been stored.

Data can be further exploited in the subsequent modules to perform statistical analyses as well as information retrieval.

Usefully, it is pointed out that a huge amount of data stored in a common database encourage the use of data mining techniques and pattern recognition algorithms. This enables better understanding of hardly exploitable relations between entities involved during the game.

According to the invention (and for both the embodiments of the system 100, 200) the video processing module 102, 202 produces (and saves into the database 103, 203) the following low-level data:
the 3D position of the contact of the ball B on the ground. This information is relevant in order to assess the right execution of the serve and the right execution of the game play after the serve(s) (rallies for example);
the 3D position of the game (serve). In other words, it is the beginning of the first trajectory of the game play;
the 3D position of the movement inversion or impact of the ball B, that is, the position where the ball is hit by the player P1, P2;
the 3D position of the player P1, P2 (center of mass);
the 3D position of the center of mass of the ball B compared to the one of the player P1, P2. It is functional to detect the type of shot (forehand or backhand, for instance).

The time reference is the one of the timestamp of the frame. Therefore, for example, if for the 3D position of the impact of the ball B on the ground a real frame is not available, the closest frame time-wise will be associated to that event.

Furthermore, the video processing module 102, 202 produces aggregates multiple events in order to generate and store in the database 103, 203 medium-level data, i.e. more complex events that depend on the time consecutivity of specific basic events.

Just as an example: a shot will be considered a “passing shot”, if the player P1 gets closer to the net after the serve (on the right or “Deuce” side) and the opponent's P2 return (the player is located on the right or “Deuce” side) is not intercepted by the player P1 himself.

So, at this level, we consider basic events related to the ball B and at the same time basic events related to the position of the players P1, P2. At this level as well, the outcome of the game play in other words the “score” is taken into consideration.

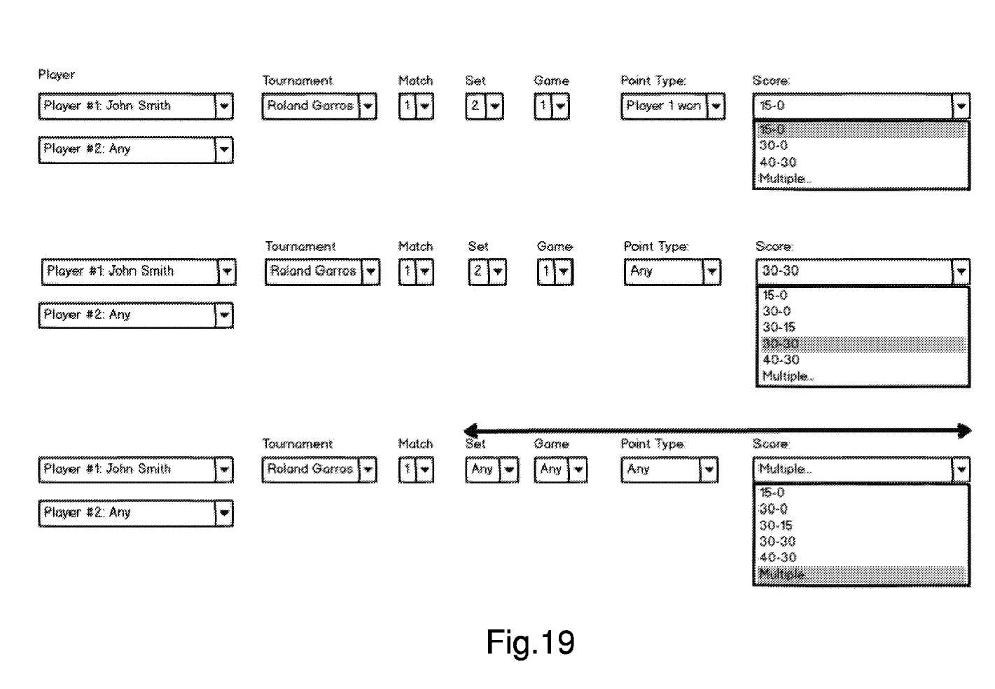

As an example, the logic of this level of processing is represented with finite state automata in FIG. 18.

Particularly, the state diagram of FIG. 10 represents tennis play states for two teams competing for points by serving at ad or deuce point scores.

For team T1 starting at state S1 “Server T1 DEUCE” S1: state transition from S1 to state S2 “Bounce IN—Court T2” if serve is good, otherwise state transition to “Fault Serve T1 DEUCE” S3, from S3 the state transitions to “2^{nd} Serve T1 DEUCE” S4, from S4 to “Bounce IN Court T2” S2 and then transitions to “Shot T2” S5, otherwise T1 gets the point.

For team T1 starting at state “Server T1 AD” S6: state transition from S6 to “Bounce IN—Court T2” S2 if serve is good, otherwise state transition to “Fault Serve T1 AD” S7, From S7 the state transitions to “2^{nd} Serve T1 AD” S8, from S8 to “Bounce IN Court T2” S2 and then transitions to “Shot T2” S5, otherwise T1 gets the point.

For team T2 starting at state “Server T2 DEUCE” S9: state transition from S9 to “Bounce IN—Court T1” S10 if serve is good, otherwise state transition to “Fault Serve T2 DEUCE” S11, From S11 the state transitions to “2^{nd} Serve T2 DEUCE” S12, from S12 to “Bounce IN Court T1” S10 and then transitions to “Shot T1” S13, otherwise T2 gets the point.

For team T2 starting at state “Server T2 AD” S14: state transition from S14 to “Bounce IN—Court T1” S10 if serve is good, otherwise state transition to “Fault Serve T2 AD” S15, from S15 the state transitions to “2^{nd} Serve T2 AD” S16, From S16 to “Bounce IN Court T1” S10 and then transitions to “Shot T1” S13, otherwise T2 gets the point.

“Shot T1” S13, transitions to state “Shot T2” S5 if the bounce is in, otherwise S13 transitions to “Bounce OUT Court T2” S17 and T2 gets the point.

“Shot T2” S5, transitions to state “Shot T1” S13 if the bounce is in, otherwise S5 transitions to “Bounce OUT Court T1” S18 and T1 gets the point.

After a serve is successful at state S2 or S10, rallies repeat states S5-S13-S5-S13 until a player hits the ball out. This “rally” can be a short or long rally.

The tables of the database 103, 203 related to “game”, “set”, “match”, “action” are populated at this medium-level. Even at this level, it is possible to question the database 103, 203 with exemplary queries as far as following data concern:
score stats;
stats on a recurring event for instance “a position of the ball”;
stats on one player's position;
stats on the typology of winners; and
stats on the typology of errors.

The following list comprises a list of example queries that can be made in response to the data generated at every conceptual level.

Parameters: trajectory of the ball, bounce of the ball, speed of the ball/players, acceleration of the ball/players, peak speed of the ball/players, pace variation (variation of speed/spins during rally), length, height, impact, distance, time (inter contact time, effective time, elapsed time, in between point(s), change-over(s) (game break)—90″, rest time (set break)—90″, medical time, time from Pt to 2^{nd} serve, side(s), right, left), directions (cross-court, down-the-line), angles (T-zone, Wide, Body) a.s.o.

Events: forehand, backhand, smash, volley smash, bounce smash, serve, Pt serve, 2^{nd} serve, return, return to 1^{st} serve, return to 2^{nd} serve, forehand volley, backhand volley, drop-shot, half-volley, bounce and impact locations a.s.o.

Line calling: in, out, net.

Outcome (point): point won, point lost.

Score: in the game (points), in a tie-breaker (points), in a set (games), in a match (sets), point sequencing (point # in the game), game sequencing (game # in the set), point streak (points scored in a row or “momentum within a set”) game streak (games scored in a row or “momentum within a set”) a.s.o.

Scorecard: meta-data (tournament, round, time, winner, players, name, date/place of birth, nationality a.s.o.), statistics on service (# of Aces P1/P2, # of Double Faults P1/P2, 1st serve % of P1/P2 (#P1/#P2), 1st serve points won % of P1/P2 (#P1/#P2), 2nd serve points won % of P1/P2 (#P1/#P2), break points saved % of P1/P2 (#P1/#P2), # of service games played (#P1/#P2)), statistics on return (1st serve return won % of P1/P2 (#P1/#P2), 2nd serve return won % of P1/P2 (#P1/#P2), break points converted % of P1/P2 (#P1/#P2), return games played (#P1/#P2)), statistics on points (total service points won % of P1/P2 (#P1/#P2), total return points won % of P1/P2 (#P1/#P2), total points won % of P1/P2 (#P1/#P2)).

Pattern Recognition (to be combined with all previous data): serve-return, serve-return-3^{rd} shot, serve-return-4^{th} shot, serve-return & from 3^{rd} to 5^{th} (shots),

serve-return & from 3^{rd} to 9^{th} (shots), serve-return & from 3^{rd} to 12^{th} (shots), serve-return & from 3rd to 15th (shots), serve-return & from 3rd to >15^{th} (shots), the winner/error, the winner(s), ace, dirt ace, the two bounce rule.

Advantageously, the system 100, 200 according to the invention comprises a pattern recognition functions, intended as functions to be combined and integrated with all previous data in order to find tendencies, similarities and differences in the players' behaviors.

For example, pattern recognition could include: serve-return two-shot pair (the so called “tensor” as discussed below) combinations, serve-return-3rd shot tensor, serve-return-4th shot tensor (0 to 4 shot patterns of play); from 5th to 6th shot tensor, from 6th to 7th shot tensor, from 7^{th} to 8^{th} shot tensor (5 to 8 shot pattern of play); from 8^{th} to 9^{th} shot tensor, from 9^{th} to 10^{th} shot tensor, from the 10^{th} shot tensor to the “X” shot tensor (more than 9 shots pattern of play); the last shot tensor determining the outcome of the point, from the last shot tensor to the second last shot tensor, the winner/error ratio, the # of winners, of aces and of unreturned serves a.s.o.

This pattern modeling effort defines implicitly “borderline zones” that can not be solved imposing simplistic mathematical calculations nor thresholds for time or space. The questions related to the above mentioned “borderline zones” can be heuristically illustrated with the so called “fuzzy logic” solutions. These identify “transition zones” not only for the players' interactions, game-styles or patterns of play, but also, as examples, used for:
the detection of ball bounce and players' positions/locations (in case of a ball bouncing between two areas of the court grid);
the interpretation of events like half-volleys to be distinguished from ground-strokes, previously defined with a time threshold after the ball bounce;
the distinction between tactical phases like as examples, “construction”, “attack” or “defense”, “net play” or “base-line game” previously identified through a space threshold according to the players' movement on-court;
the distinction between “forced” and “unforced errors” previously identified through a space/time threshold
a.s.o.

“Fuzzy logic” database solutions allow the fusion of self-referencial time/space and numeric constraints in order to build heuristic and intelligent self-regulating systems ensuring more flexibility to database inquiries for VR and AR effects.

Advantageously, the integrated and aggregated high-level cross-over data allow to reply to questions as (examples): “I lost my last match against a given player, where/what/when/how might I do better?”, “How can I improve my preparation in order to overcome these limitations?”, “Which game play, patterns of play, players' behaviors, or even ball parameters repeatedly occur, so that these lead or justify a positive/negative outcome in the score?”, “I lost/won this point, but are there any similar situations that previously occurred that lead to a different outcome?”.

Advantageously, the system according to the invention comprises action or event filtering functions.

Particularly, actions or events happened in the actions could be further filtered or grouped down the line with action or event filtering or grouping functions, for statistical analysis and game analysis.

The multi-level database offers low-level data, medium-level data and high-level data. These data, when integrated with each other via ad-hoc queries, create an aggregate of new significance and expressiveness.

In particular, the used administrator and end-user user interface, just like the database, are structured on several menu levels.

A first upper menu is for the collection and sorting of the low-level data.

A second mid-level menu that partially integrates the low-level data in order to produce research protocols of data or characteristics of the performance of the game that allow the administrator or the end-user to easily understand and interpret the unfolding of the game itself in a unprecedented way, this being the base for VR and AR rendering solutions through graphic computer design (the so called “4th and 5th dimensions”) with the implementation of “what if” and “not imaginable” scenarios.

These data are then intersected with a third statistical grouping menu for the use of classical statistical data, but also transversal statistical data, in order to have a complete follow-up of the players' interactions during game play.

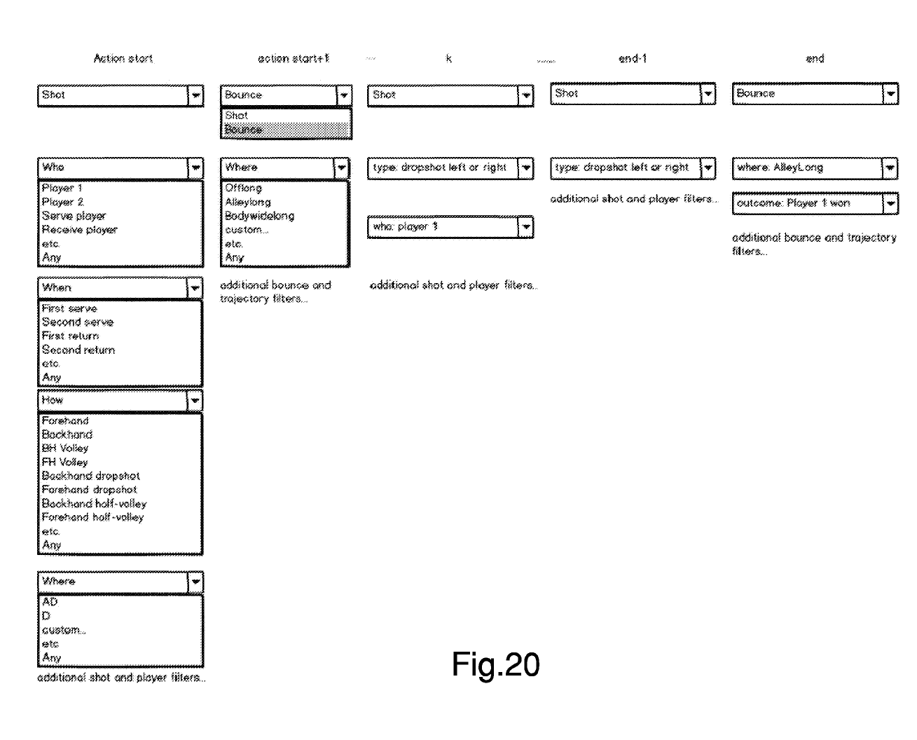

According to an example schematically illustrated in FIG. 19, for coarse action filtering, a first player, and optionally an opponent player, can be selected.

Tournaments/Training sessions where the player(s) were present can be filtered in cascade.

Matches, sets and games can be explicitly selected and drilled down. Additionally, queries can be related to actions/events of a particular point type, i.e. any (all), player 1 won, player 1 lost, first serve, second serve, match point, etc.

More than one action can be explicitly selected, even on different sets or games (or matches), if they have not been previously constrained.

As illustrated in FIG. 20, actions can be further filtered through action attributes, such as action time length, action length (rally length) and so on. Additional action attributes can be used for grouping purposes.

Actions or action parts can be further filtered through the use of event-based filtering.

It works by temporally chaining different event types (shots, bounces or nets) together and constraining each event to a particular set of rules.

Temporal markers can be broadly subdivided in:
action start event—0 or 1;
middle action event(s)—0 or more possible;
action end event—0 or 1;
predecessor(s) or successor(s) event(s)—0, 1 or more.

One or more temporal markers can be chained forming temporal relationships. Each temporal marker can be either be related to a shot event, bounce event or net event. Event-specific filters can be further specified for the chain event. They can be either referred to player(s) data (including inter-players information such as player's mutual distance), bounce or trajectory information, or additional player-ball metrics. These event-specific filters can be further chained together.

Of particular interest is the main-menu section dedicated to the identification of events and characteristics related to the events themselves.

In particular, it is noted that in the present description the term “event” is defined as one element of a possible “triplet” CP1-r-CP2, where CP1 defines the shot hit by a first player P1, r possibly identifies the bounce of the stroke of the first player P1, and CP2 possibly defines the shot of the player P2.

These “events” are organized in “potential” triplets or “combinations” because yet at the time of the start shot of the point (serve) the occurrence of these triplets is not certain.

In fact, the serve of the player P1 is only good (IN) if the ball bounces in a specific playing surface (the correct side service box). If so, a CP1-r string is created with multiple outcomes that can possibly end with the next shot event of the opponent player P2.

Therefore, each triplet of events constitutes a “tensor” where the conclusion of the string represents the basis and the start of the potential next triplet.

Based on the concept of “tensor”, it is possible to define following tern of relations:

0-1 (service point not assigned or double fault)

1-2 (Service-bounce-return)

2-3 (return-possible bounce-shot #3) and so on in case the point comprises a higher number of impacts.

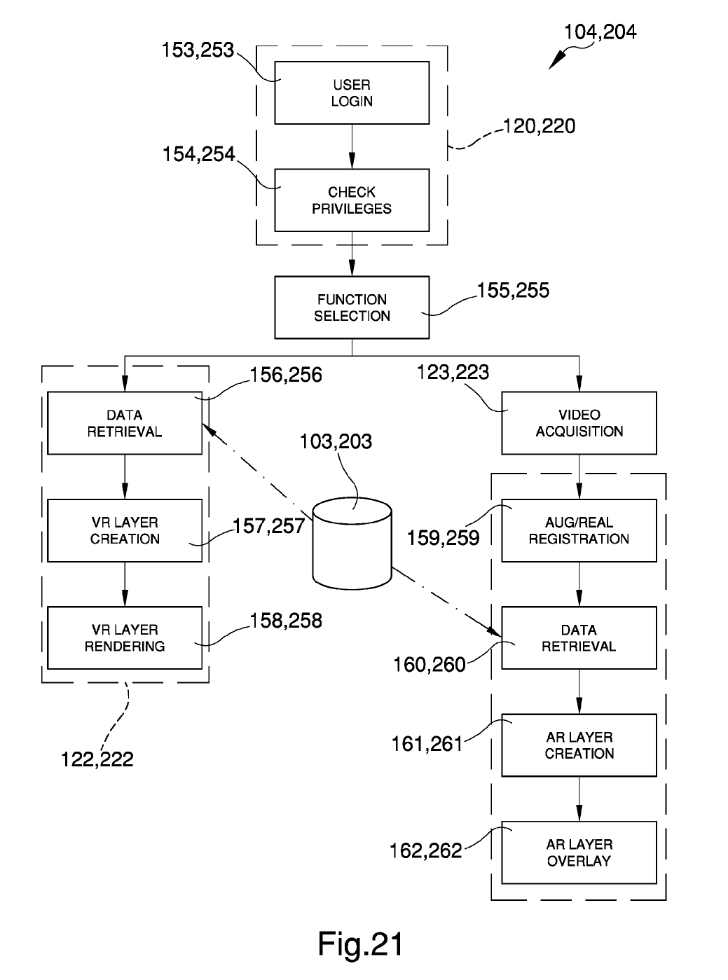

FIG. 21 shows a more detailed level data-flow of the debriefing module 104, 204, particularly of the user authentication unit 120, 220, of the virtual reality unit 122, 222 and of the augmented reality unit 124, 224 as illustrated in FIGS. 3 and 11 concerning the first and the second embodiments of the system 100, 200.

Particularly, the user authentication unit 120, 220 comprises a user login block 153, 253 for entering user ID, user password or other identification codes. Furthermore, the user authentication unit 120, 220 comprises a check privileges block 154, 254 for checking the correctness of the entered data.

The debriefing module 104, 204 further comprises a function selection block 155, 255, wherein it is possible to select between virtual reality services or augmented reality services.

The virtual reality unit 122, 222 comprises a data retrieval block 156, 256 connected to the database 103, 203 and suitable for retrieving all the low-level, medium-level and, particularly, high-level data.

Furthermore, the virtual reality unit 122, 222 comprises a VR layer creation block 157, 257 and a VR layer rendering block 158, 258.

Virtual reality examples are related to a full list of virtual rendering of the game through avatars, virtual play-fields, etc.

One interesting application is the virtual reconstruction of “what-if” scenarios representing match play in a “not imaginable way” based on artificial intelligence techniques and large amount of recorded data. In this case, also through the wide experience of experts in the tennis game field, it will be possible to create virtual simulations of alternative situations which may occur, for example, if the player had used different shots and this also for broadcast entertainment use.

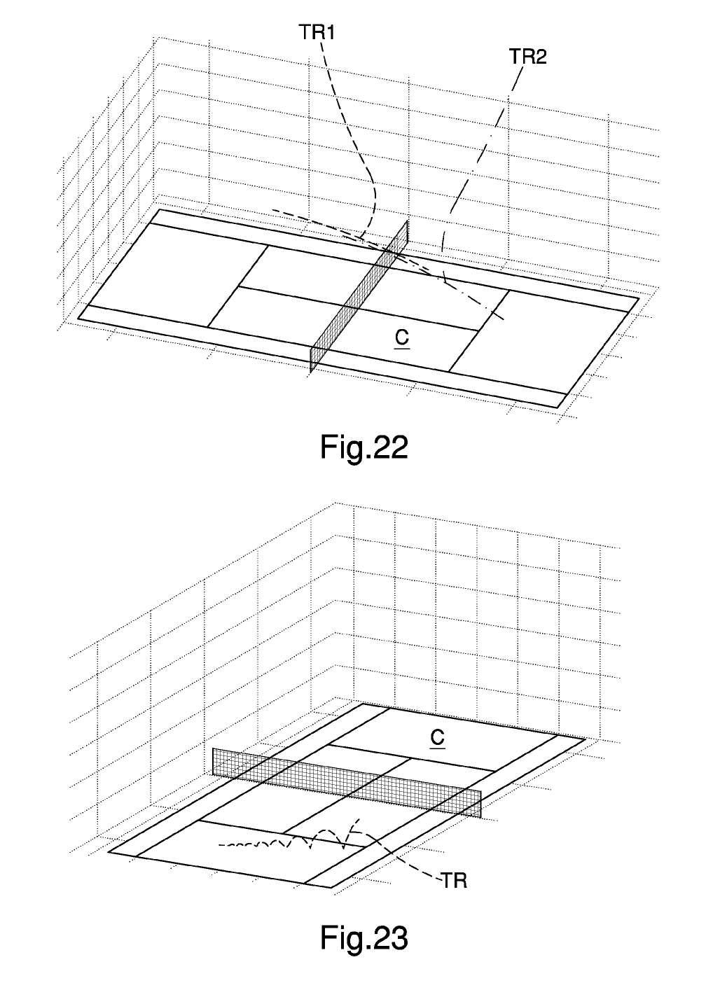

FIGS. 22, 23 and 24 provide examples of computer-generated images of a simulated tennis court C generated by the system 100, 200 according to the invention, wherein data representing ball flight, or ball trajectory, as captured by at least a camera 101, 201 is being processed.

The trajectories illustrated in the figures are exemplary ball flight paths superimposed on computer generated tennis court C images.

Analytic knowledge of the trajectory of a ball is good for extracting a presumed impact position of the ball on the ground.

Comparatively, the 3D positions of the players are determined via triangulation. This information is registered in the referral tables of the database 103, 203.

The hardware/software system may be extended in order to process doubles and practice situations with a plurality of players and, above all, more balls in the scene.

In these cases, the monocular detection takes place as described while, in the reconstruction of the 3D trajectories, a compatibility check on the position of the ball is made.

In other words, the 3D detections of the ball that meet the proximity (nearest neighbour) condition belong to the same trajectory.

Examples of multiple detections verified with the cited condition are reconstructed and represented in the Figures.

Particularly, FIG. 22 shows two distinct coded trajectories TR1 and TR2.

FIG. 23 shows one ball bounce TR.

FIG. 24 illustrates a tennis point with multiple shots and trajectories TR1-TR5 with a final tensor leading to a winner. The ball inversions at high speed show highly separated ball positions, especially in the initial phase in flight. As the flight extends or the ball bounces, the in-flight ball positions become closer together indicating a slower speed ball trajectory due to the bounce reducing the ball's kinetic energy.

The trajectories TR1-TR5 could be colour coded in order to identify consecutive two-shot pairs (both a serve and a return shot as an example, building together a tensor).

Some exemplary instances of interest include the serve TR1 of a Player P1 with bounce in the T area of the deuce service box and a looping return TR2 of Player P2 bouncing IN, another event shot TR3 of P1 bouncing deep on the AD side, another event shot TR4 of P2 bouncing IN short letting the server P1 finally playing out a drop-shot winner TR5 with three consecutive bounces on the opponent's playfield.

According to FIG. 19, the augmented reality unit 123, 223 comprises an AR registration block 159, 259, an AR data retrieval block 160, 260, an AR layer creation block 161, 261 and an AR layer overlay block 162, 262.

In contrast to VR, AR requires a real-time continuous registration of real images (captured, for instance, through the camera embedded on a mobile device) with virtual objects. Thus a further module of real-time image processing on board of the device has been conceived.

In terms of possible functions of VR and AR within the embodiments described herein, some are listed and depicted.

Augmented reality examples include virtual rendering of different court surfaces or grounds superimposed to the real one (for instance red sand or green clay court surface instead of blue hard court).

Augmented reality examples may include virtual rendering of avatars on the real playground to mimic the real plays of the match.

Augmented reality examples may include adding contextual information as virtual objects in the scene.

Augmented reality may therefore enhance conventional tennis court views.

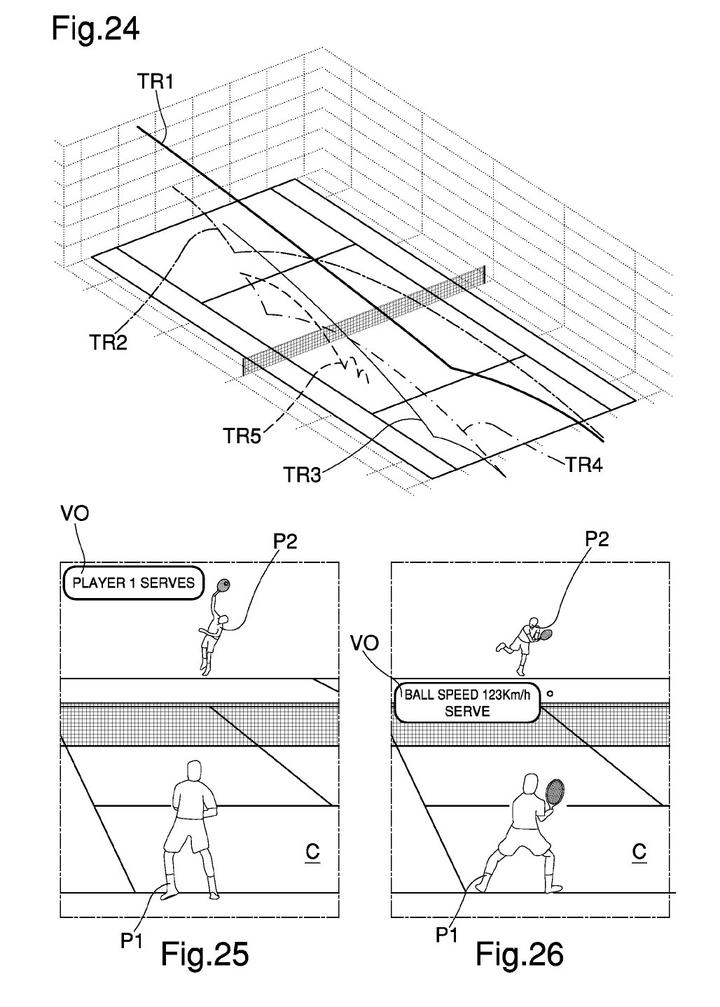

As examples, FIGS. 25, 26 and 27 schematize photographic views of a tennis point.

As seen in such figures, added contextual information are placed as virtual objects VO in the scenes.

Such added contextual information may comprise semi-transparent virtual boxes displaying the speed of the ball, specific shots of the player, the match score, cross-over/transversal statistics, and other information.

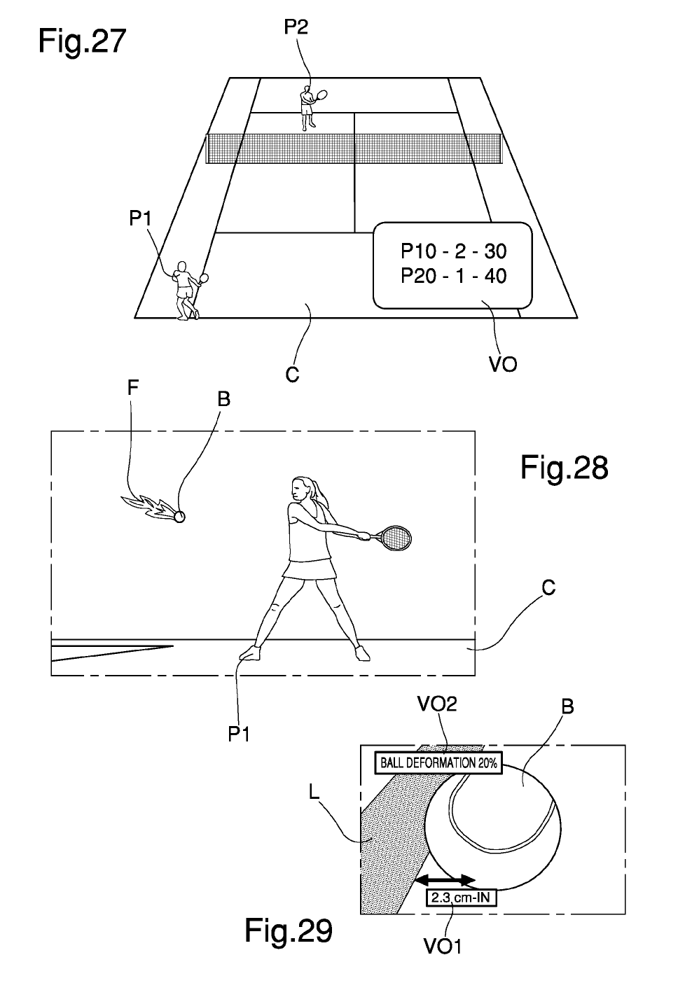

Augmented reality examples include adding, by the user, cartooning effects to the game play. An example is the addition of “flames” F coming in behind a ball B for high-speed hits as schematically illustrated in FIG. 28.

Augmented reality examples may also include virtual line calling with slow motion replay and virtual additions. For example, as schematically illustrated in FIG. 27, virtual objects VO1 and VO2 are added in order to show relative dimensioned distance of a ball B to a line L or ball deformation.

The systems 100, 200 and methods described herein add such augmented reality effects on a live feed delivered in real-time under at least one embodiment.

In other embodiments, a user/viewer may request and receive personalized statistics and effects on a match he/she is currently viewing.

In one embodiment of the systems 100, 200 herein, the camera 201 or cameras 101 are not controlled by the operator and are not part of the system; instead, the video acquisition module 110, 210 of the system 100, 200 comprises a third-party video acquisition block for acquiring a video file that has been created by a third person using his or her own camera.

In this instance, a video clip representing a tennis match as recorded by the separate person or entity is downloaded into a processing system. The video clip may be, for example, from YouTube®, Vimeo®, or any tennis websites.

In one aspect, the process of “downloading” means orienting a mobile device having a camera to a source of a video stream (such as a TV screen or any other related devices).

The software installed in a mobile or portable device and integrated in an App will allow the user to process the chosen video clip or the represented images and extract data from them about the performance of the players, as described above.

The video clips should have predefined characteristics related to the quality of the video itself. For instance:
HD resolution in accordance with the single camera system using a “mobile device”; this allows the players and the ball to be seen and processed in every action and interaction;
at least 25 FPS;
rear broadcast view in order to allow the view of both players' interactions during match play;
the image should be stable, meaning that the video being recorded is “fixed” (in a sense that the obtained image plan does not tilt nor change);
the recording device should be located as high as possible in order to avoid possible occlusions between players and/or players and the ball(s);
in case the video clips will be made available via websites or the like, the videos should be compressed via compression standards (H-264, Mpeg-4, etc.) that will adapt the algorithms to the different needs required by the systems themselves;
the extractions via the software will be submitted to the same limitation.

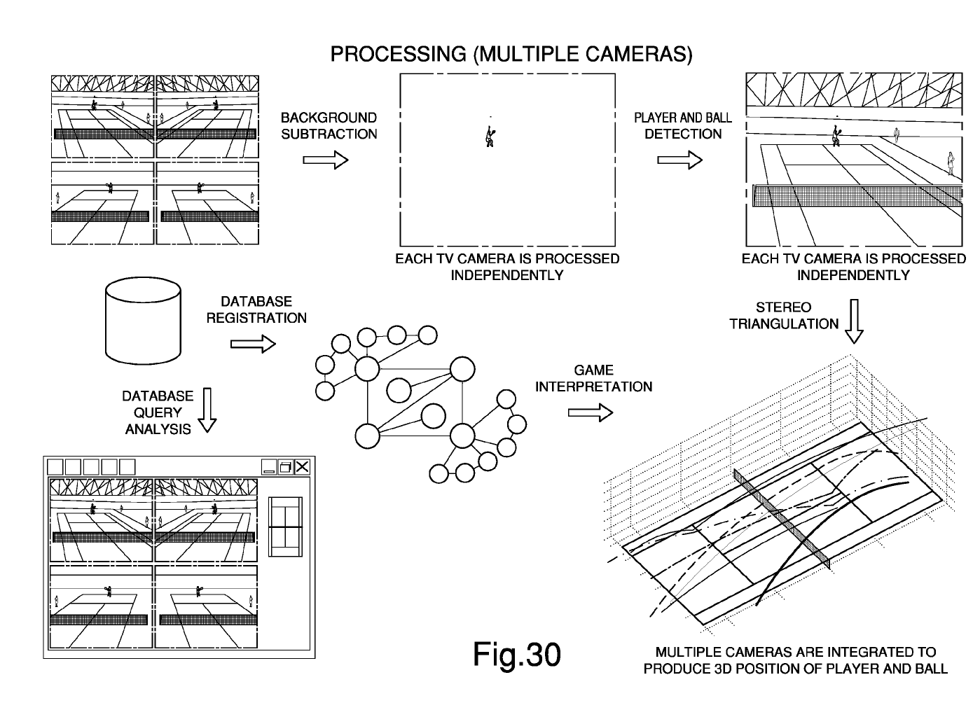

FIG. 30 is a flow chart showing the overall operation of the system 100 according to the invention, in the first embodiment.

In this flow chart, video data is acquired from multiple cameras 101 to provide image acquisition.

Each camera image is stored and processed independently at a server 105, 106, which employs a background subtraction algorithm.

The background subtraction algorithm computes the background—intended as part of the image which is not in motion—and subtracts it from the current image to generate the moving parts of the image, which should be the players and the ball.

As images are also processed using stereo triangulation, the server performs database query analysis and database registration.

Scoring logic of this level of processing is expressed with finite state automata.

The game interpretation and stereo triangulation from multiple cameras are integrated to produce 3D position of the player and ball for superimposition onto a virtual reality playing surface/court.

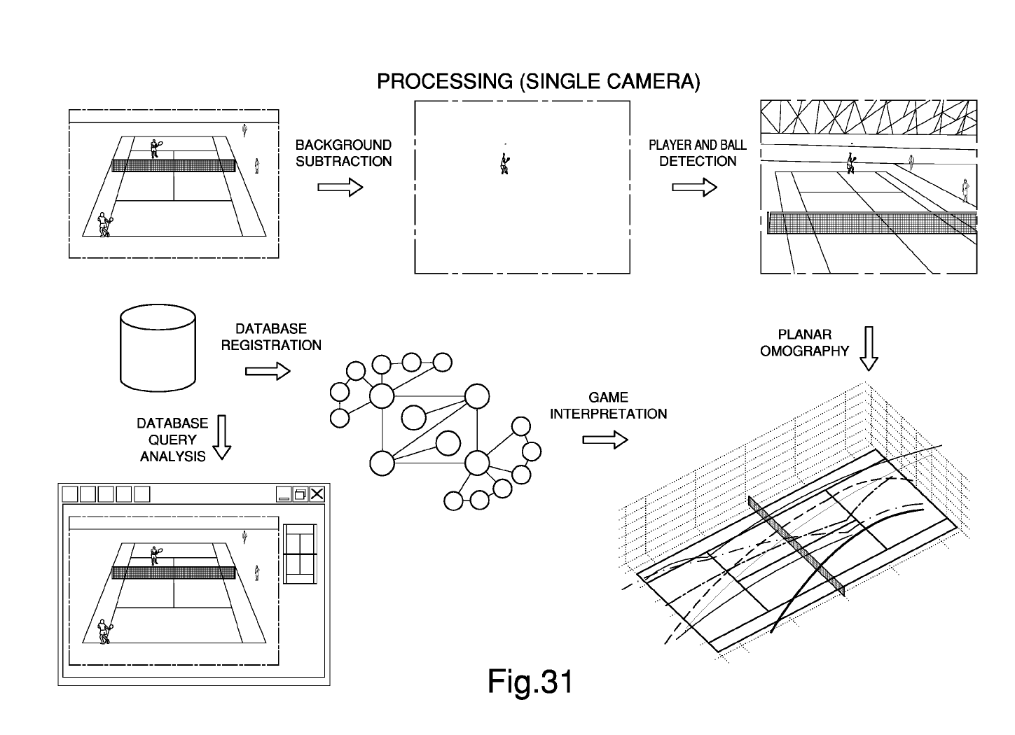

FIG. 31 is a flow chart showing the overall operation of the system according to the invention, in the second embodiment.

In this flow chart, video data is acquired from a single camera to provide image acquisition.

The camera image is stored and processed by a server which also employs a background subtraction algorithm used for player and ball detection.

As images are also processed using planar homography, the server performs database query analysis and database registration.

Scoring logic of this level of processing is expressed with finite state automata.

The game interpretation and planar homography from the single camera is used to produce 2D position of the player and ball for superimposition onto a virtual reality playing surface/court.

Advantageously, the multilevel database 103, 203 by embedding low-medium-high-level data, allows a cross-fruition of data for statistical and performance analysis of the game and continuous comparisons between what takes place in real-time as part of the game presently going on and what has been done in the past (past matches/tournaments/championships or parts of them) or in previous games/points of the match play.

In addition, it is possible to integrate the database 103, 203 of the system 100, 200 according to the invention to an external database comprising further different information working as constraints, set-ups or even as preliminary conditions, in order to generate new predictive data.

In particular, the database 103, 203 of the system 100, 200 and the above mentioned external database could be coordinated and integrated each other through a “data mining”, intended as a system capable to create an additional derived database.

From the derived database, just as an example, predictive information is then obtainable about the player's characteristics, behaviours and tendencies of play related to different conditions, i.e. weather conditions (various and different temperatures, humidity levels, rainy/cloudy environmental contexts a.s.o.), types of court surface, specific diet food or other specific environment.

In practice it has been observed how the described invention achieves the intended objects.

Particularly, the system according to the invention allows the automatic generation of high-level cross-over statistic information in real-time or close to real-time about a tennis match or the like.

The statistics extracted by the present invention are more complete and are high-level information; this will provide a more insightful analysis of the player performance aimed at improving his/her skills.

Furthermore, the system according to the invention allows a user to employ a conventional camera that is part of a so-called “smart-phone” (or other device having a transceiver and an appropriate application software program [“App”] installed), to record video motion of players on a tennis court, and then simulate that play by uploading the video acquisition data to a server.

Furthermore, the system according to the invention allows the processing of acquired video in order to obtain virtual reality or augmented reality video images.

Particularly, the debriefing module is more advanced with respect to the prior art thanks to augmented reality and innovative reasoning engine, with the final objective to provide simple yet effective suggestions for the player, including what-if scenarios.

Furthermore, the system according to the invention allows a user having a smart-phone (or other device having a transceiver) to receive and display processed images from multiple cameras at strategic court locations.

Furthermore, the present invention is not limited to the use of a plurality of cameras.

1. System for the automated analysis of a sporting match, comprising:
at least a video acquisition module for receiving video data related to a tennis match;
a video processing module operatively connected to said video acquisition module and suitable for processing said video data;
at least a database operatively connected at least to said video processing module and suitable for saving the processed video data; and
at least a debriefing module operatively connected to said database for the debriefing of said processed video data on at least a user device;
wherein said video processing module comprises a high-level analysis unit for generating high-level statistic data from said processed video data.

2. System according to claim 1, characterized in that it comprising a plurality of on-site cameras placed around a tennis court in order to acquire said video data of a tennis match and operatively connected to said video acquisition module for supplying said video data to the video acquisition module itself.

3. System according to claim 1, characterized in that it comprising a single camera placed adjacent a tennis court in order to acquire said video data of a tennis match and operatively connected to said video acquisition module for supplying said video data to the video acquisition module itself.

4. System according to claim 1, characterized in that it comprising at least one mobile device provided with at least a camera for acquiring said video data of a tennis match, said mobile device being operatively connected to said video acquisition module for supplying said video data to the video acquisition module itself.

5. System according to claim 1, wherein said video acquisition module comprises a third-party video acquisition block for acquiring a video file that has been created by a third person using his or her own camera.

6. System according to claim 1, wherein said video acquisition module comprises at least a video acquisition unit connected to a respective camera and at least a transmission unit connected to said video acquisition unit and suitable for the transmission of said acquired video data to said database.

7. (canceled)

8. System according to claim 1, wherein said video processing module includes at least a ball detection and tracking unit for detecting and tracking the ball trajectory from said video data.

9. System according to claim 8, wherein said ball detection and tracking unit comprises at least a background subtraction block that automatically computes the background and subtracts it from a current image of said video data and at least a region growing block operatively connected to said background subtraction block and suitable for growing the regions detected by the background subtraction block to connect adjacent regions related to an object to be detected.

10. (canceled)

11. (canceled)

12. System according to claim 1, wherein said video processing module comprises at least a ball trajectory reconstruction unit operatively connected to at least a ball detection and tracking unit.

13. (canceled)

14. (canceled)

15. System according to claim 1, wherein said video processing module comprises at least a player detection and tracking unit for detecting and tracking at least a player position from said video data.

16. System according to claim 15, wherein said player detection and tracking unit comprises at least a player mass center determination block for the determination of the player's mass center location.

17. System according to claim 1, wherein said high-level analysis unit comprises at least a point classification unit for providing low-level data and mid-level data related to the tennis match dynamics.

18. (canceled)

19. System according to claim 17, wherein said point classification unit comprises at least an estimate court impact position block for estimating player-ball impact position.

20. System according to claim 17, wherein said high-level analysis unit comprises at least a classification fusion unit operatively connected to said at least a point classification unit, for providing high-level data starting from the obtained low-level data and mid-level data.

21. System according to claim 1, wherein said point classification unit performs the following steps:
divides the point in invalid point or valid point; and
for each valid point, determines if it is a point without outcome or a point with outcome.

22. (canceled)

23. Method for the automated analysis of a sporting match, comprising the following steps:
video acquisition of video data related to a tennis match;
video processing of said video data; and
debriefing of said processed video data on at least a user device;
wherein said video processing comprises a high-level analysis for generating high-level statistic data from said processed video data.

24. Method according to claim 23, wherein said high-level analysis comprises saving of said processed video data in a multi-level database organized in low-level data, medium-level data and high-level data, and in that said high level analysis comprises action or event filtering or grouping functions for cross-over/transversal statistical analysis.

25. Method according to claim 23, wherein said high-level analysis comprises pattern recognition functions to be combined and integrated with said processed video data in order to find tendencies, similarities and differences in the players' behaviors.

26. System for the automated analysis of a sporting match, comprising:
at least a video acquisition module for receiving video data related to a tennis match;
a video processing module operatively connected to said video acquisition module and suitable for processing said video data;
at least a database operatively connected at least to said video processing module and suitable for saving the processed video data; and
at least a debriefing module operatively connected to said database for the debriefing of said processed video data on at least a user device;
wherein said debriefing module comprises at least a augmented reality unit for providing statistics and information by augmented reality services.

27. (canceled)

28. (canceled)

29. (canceled)

30. (canceled)

31. System for the automated analysis of a sporting match, comprising:
at least a video acquisition module for receiving video data related to a tennis match;
a video processing module operatively connected to said video acquisition module and suitable for processing said video data;
at least a database operatively connected at least to said video processing module and suitable for saving the processed video data; and
at least a debriefing module operatively connected to said database for the debriefing of said processed video data on at least a user device;
wherein said debriefing module comprises at least a virtual reality unit for providing statistics and information by virtual reality services.
